(19) United States
(12) Patent Application Publication
(10) Pub. No.: US 2010/0212710 A1
(43) Pub. Date: Aug. 26, 2010

(54) Supporting Profile and Connecting Profile with Reinforcing Insert as well as Method for Producing a Fiber-Reinforced Metal Profile

(75) Inventor: Heinz Röder, Buedingen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Roeder HTS High Tech Structures KG, Kefenrod (DE)

(21) Appl. No.: 12/709,646

(22) Filed: Feb. 22, 2010

(30) Foreign Application Priority Data
Feb. 25, 2009 (DE) 20 2009 002 696.5

(51) Int. Cl. E04H 15/34; E04H 15/32; B32B 37/02

(52) U.S. Cl. 135/121; 135/120.3; 156/293

(57) ABSTRACT

A supporting profile and connecting profile made of light metal for a self-supporting scaffold is disclosed. The profile is particularly for light construction halls and large tent structures, with at least one reinforcing insert extending in the longitudinal direction of the profile body made of a fiber composite material where in a cross section of the profile body that is perpendicular to the longitudinal direction of the profile body at least one closed chamber is formed, in which the at least one reinforcing insert is fixated by material connection, form-fit and/or force-fit.

The invention concerns a supporting profile and connecting profile made of light metal for a self-supporting scaffold, particularly for light construction halls and large tent structures that has at least one reinforcing insert made of a fiber composite material that extends in the longitudinal direction of the profile body. Further, the invention concerns a method for the production of a fiber-reinforced metal profile.

The invention concerns a supporting profile and connecting profile made of light metal for a self-supporting scaffold, particularly for light construction halls and large tent structures that has at least one reinforcing insert made of a fiber composite material that extends in the longitudinal direction of the profile body.

Profiles of this type are known from WO 01/46536. These known supporting profiles and connecting profiles have the reinforcement layers (inserts) in recesses of the outer surface of the profile body, whereby the reinforcement layers are exposed in sections toward the inside or the outside and are not completely enclosed. Depending on the type of connection between the profile body and the reinforcing insert, forces of different magnitude can be transmitted from the profile body to the reinforcement layers.

A particular problem exists in the production of supporting profiles and connecting profiles that are to be used in light construction halls and large tent structures. In these structures, the supporting profiles and connecting profiles can sometimes reach a length of over 10 meters. Here, it has been shown to be particularly difficult in the past to establish a good permanent connection between a fiber reinforcement and the metal profile, which most often consists of aluminum. Thereby, it is of particular importance that structures of this type are also exposed to various climatic conditions. Thus, fiber-reinforced supporting profiles and connecting profiles must also be able to maintain a secure connection between the fiber reinforcement and the metal profile, at least in a temperature range of −20° C. to 80° C.

It is therefore the problem of the present invention to improve the connection between the reinforcement layer (insert) and the profile body, whereby the reinforcement layer (insert) is to be simultaneously especially effectively protected from any damage.

This problem is solved by the present invention essentially thereby, that in a cross section of the profile body that is perpendicular to the longitudinal direction of the profile body at least one closed chamber is formed in which at least one reinforcing insert is fixated by material engagement, form engagement and/or force-fit. A closed chamber surrounding the connecting profile offers the advantage that the forces can be initiated or absorbed over the entire reinforcing insert. Moreover, the reinforcing insert is effectively protected against mechanical or other damage in the closed chamber in the profile body. The thus achieved optimal utilization of the physical properties of the reinforcing insert by considering the loads that occur, also makes a reduction of the dimensioning of the profile body material possible. The reason for this is that the forces, particularly the bending moments and the tensile forces and compressive forces such as they occur, for example, in the case of wind loads, are primarily absorbed by the reinforcing insert and do not need to be borne by the profile body.

If the reinforcing insert is molded into a chamber, a very robust and high force-transmitting connection between the reinforcing insert and the profile body is established having the effect of a high degree of stability and strength for the entire scaffold construction. Simultaneous or separate gluing of the reinforcing insert into the profile body also ensures a secure connection between profile body and reinforcing insert. Alternatively or additionally, it is possible to use a rivet connection or screw connection for the fixation of the reinforcing insert onto the profile body.

In principle, it is possible that the closed chamber is formed out of two or more elements. For this, according to an embodiment that offers advantages especially with respect to assembly, a closed chamber can be formed by a wall section of the profile body, as well as by a covering or the like. Thereby, the covering can be connected detachable with the profile body by means of, for example, clamp, catch, snap or plug connections. It is preferred, however, if the at least one closed chamber is designed in one piece with the profile body.

According to an especially preferred embodiment of the invention, the at last one closed chamber is designed in such a way that its lumen in a cross section that is perpendicular to the longitudinal direction of the profile body is larger than the reinforcing insert. In other words, between the inner surface of the chamber and the outer surface of the, for example, fiber reinforcement that is designed lamella-like, a gap remains, which can be used for gluing the fiber reinforcement onto the profile. Face-to-face gluing on all sides with the exception of the facing sides is very helpful for a good connection of the fiber reinforcement with the metal profile. The fiber reinforcement can only be used effectively for absorbing tensile forces or compressive forces, if a good adhesion with the metal profile of this type is present.

In the further development of this inventive idea it is provided that on the inner side of the at least one closed chamber and/or on the outer side of the reinforcing insert, at least one guide element and/or distance element is provided. Such a distance element and/or guide element can preferably be designed as a rib extending in the longitudinal direction of the profile body. However, several point-shaped or bar-shaped protrusions distributed evenly or irregularly over the inner surface of the profile body or over the outer surface of the reinforcing insert can be used for this as well. It is important that the guide elements and/or distance elements establish a defined minimum distance between the outer side of the reinforcing insert and the inner side of the closed chamber. It is possible as a result of this to also achieve a two-dimensional adhesion of the reinforcing insert with the metal profile over the entire length of the profile. Thereby, it does not matter if the inner side of the chamber or the outer side of the reinforcing insert is actually in contact or is at least very close in the section of the guide elements and/or distance elements, as long as otherwise, a two-dimensional adhesion is made possible. The use of guide elements and/or distance elements is especially important then, when the supporting profiles and connecting profiles in accordance with the invention are long, i.e. they are several meters long, for example, as the fiber reinforcement could otherwise bear on a surface of the chamber with its underside because of gravity, so that no adhesion could take place there.

For achieving high fire-resistance of the profiles, chemicals that are difficult to inflame can be mixed into the profile body. In this way, adherence to the guidelines that are in force for the construction and operation of tents can be observed, among other things. Thus, it is mandated in the guidelines for tent construction or hall construction that all construction materials must at least be difficult to inflame as per DIN 4102 Part 1. Standard inflammable construction materials as per DIN 4102 Part 1 may only be used for roof covering that is higher than 2.3 m above walkable surfaces. In other countries, tents or halls are sometimes treated like other construction facilities, i.e. they are also subject to the fire prevention provisions for such construction facilities. These sometimes provide that the construction must be able to withstand fire for 30 or 60 minutes. Aluminum and steel alone cannot do this, but they deform or start to melt. As the result of the addition of corresponding chemicals such as aluminumtrihydrate, bromine or the like, fire classifications can be attained that satisfy any national fire prevention regulation.

For use in light construction halls and large tent structures, the supporting profiles and connecting profiles in accordance with the invention can be very long compared with their other dimensions. Thus, the length of the metal profiles can, for example, be larger by a factor of 20, especially however, by a factor of 50 to approximately a factor of 150, than its width and/or height. Thereby, the entire length of the fiber-reinforced metal profile can be longer than 10 meters, depending on its use.

For connecting additional construction components, particularly for connecting tarpaulins, wall elements, windows or the like, slots are preferably provided in the supporting profile and connecting profile according to the invention. It is thereby especially advantageous when the profile body is almost rectangular in a cross section that is perpendicular with respect to the longitudinal direction of the profile body, whereby its height is larger as its width, and whereby in at least two corners respectively, at least one slot is provided for housing a piping (welt) or similar. In a rectangular cross section of the profile body, it is especially preferred to place respectively one slot in each of the four corners. In principle, it is however also possible to provide slots of this type or other suitable fastening arrangements at other positions of the profile body.

In accordance with the invention, the profile body can be constructed as post, roof shingle, gable column, gable transverse traverse, roof beam, tarpaulin holder, socket, gable support with floor fastening, stick-catch connection in the eaves area, ridge connection between individual roof shingles, connection between gable supports and roof shingles, cross bracing for reinforcement between posts and between roof shingles or similar scaffolding parts. In this way, the self-supporting scaffold can be constructed entirely with profiles according to the invention.

The problem on which the invention is based is furthermore solved by a method for the production of a fiber-reinforced metal profile with the following process steps: First, a profile body is made available in which at least one closed chamber is formed in a cross section that is perpendicular to the longitudinal direction of the profile body. Subsequently, an adhesive is filled into this at least one closed chamber. Finally, a reinforcing insert containing glass fibers and/or carbon fibers is inserted together with adhesive into the chamber that has previously been filled at least partially with adhesive. This method in accordance with the invention has the effect that—with the exception of the facing side—good adhesion between the closed chamber and the reinforcing insert is obtained on all sides. As the result of the prior filling of the closed chamber with adhesive, tearing of the adhesive film between the reinforcing insert and the chamber is avoided during the joint insertion of the reinforcing insert and the adhesive. Rather, the adhesive flows around the reinforcing insert during the insertion into the chamber.

Especially in the case of very long metal profiles it has shown to be advantageous, when the metal profile, as well as the reinforcing insert are aligned essentially horizontally during the assembly. This simplifies the handling and also reduces the danger of air pockets, which could occur in a perpendicular alignment of the metal profile.

It has been shown to be especially advantageous when the viscosity of the adhesive is between 1,000 mPas and approximately 3,500 mPas. A particularly preferred range is at approximately 2,100 mPas to approximately 2,500 mPas (respectively measured at 25° C.). As particularly advantageous, additional adhesives, especially two-component adhesives with a tensile strength of approximately 20 MPa to approximately 30 MPa and/or an ultimate elongation of 200% and 400%, particularly, approximately 300% (respectively measured as per ISO 527) have been shown to be effective.

In order to achieve an especially good connection between the metal profile and the reinforcing insert it is preferred, if during the insertion of the reinforcing insert together with the adhesive into the closed chamber, an adhesive film with a layer thickness of at least 0.3 mm, particularly between approximately 0.4 mm and approximately 2.5 mm is created between the outer side of the reinforcing insert and the inner side of the chamber on all sides (with the exception of the facing sides). This can be facilitated especially by using the guide elements and/or distance elements that are described above.

It is preferred when the profile body in accordance with the invention has an almost rectangular cross section, whereby its height is larger than its width. Preferably, in the proximity of the upper side and in the proximity of the underside of the profile body, a closed chamber is provided respectively, whereby in each of these chambers an adhesive and a reinforcing insert is inserted as per the method in accordance with the invention.

In the following, the invention is explained in more detail in conjunction with the examples of embodiments and by referring to the drawing. Schematically shown are:

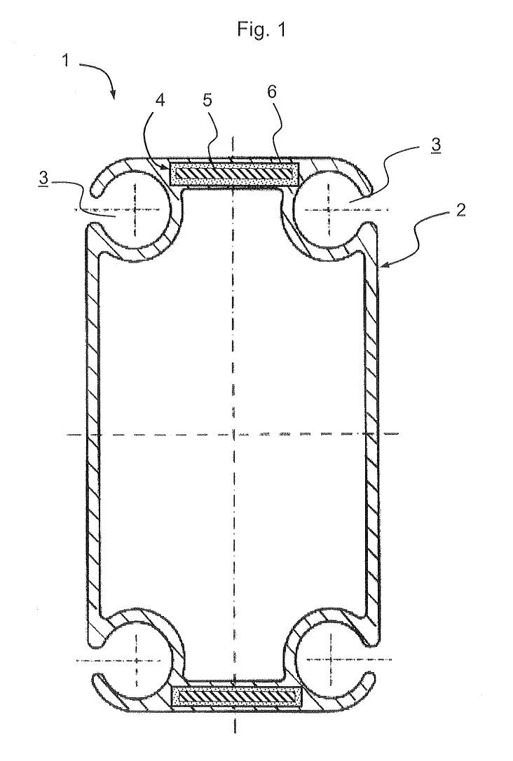

FIG. 1 a cross section through a supporting profile and connecting profile in accordance with the invention as per a first embodiment,

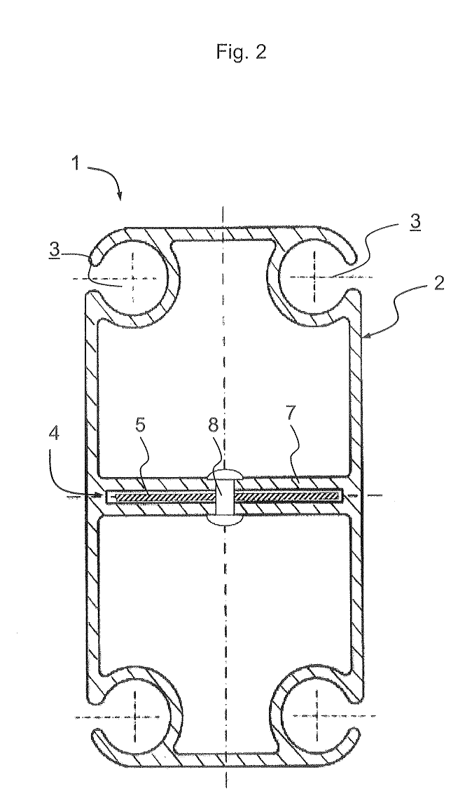

FIG. 2 a cross section through a supporting profile and connecting profile in accordance with the invention as per a second embodiment with a reinforcing insert that is fixated with a rivet connection,

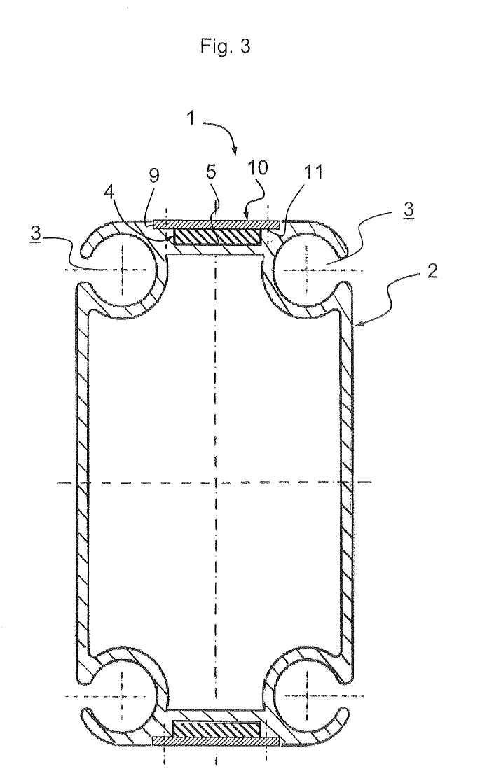

FIG. 3 a cross section through a supporting profile and connecting profile in accordance with the invention as per a third embodiment with reinforcing inserts and coverings,

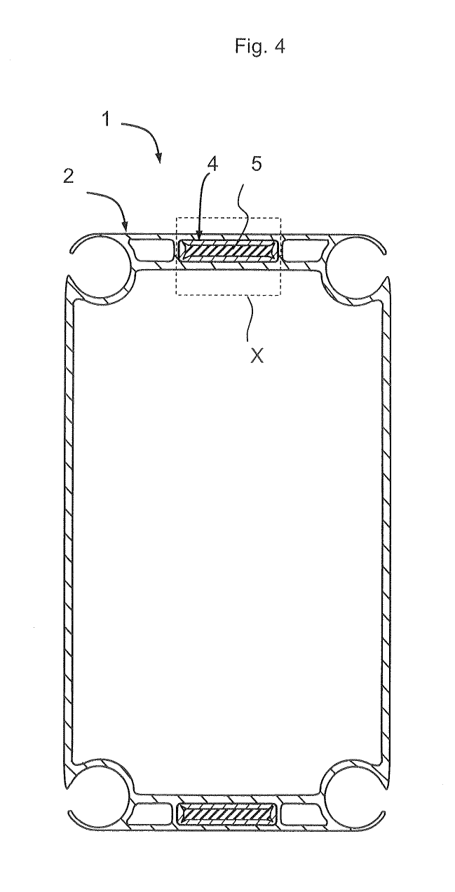

FIG. 4 a cross section through a supporting profile and connecting profile in accordance with the invention as per a fourth embodiment,

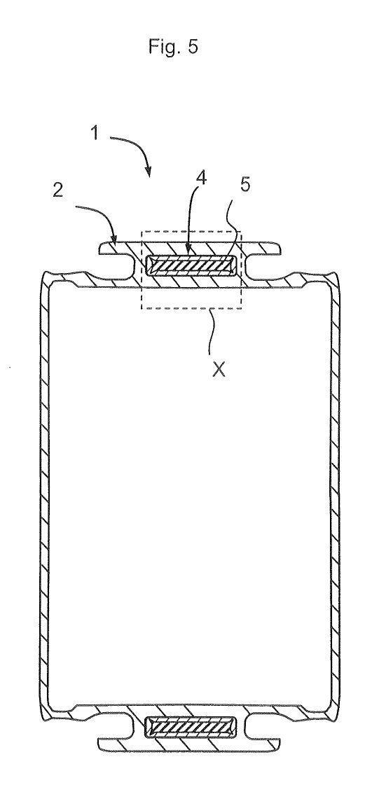

FIG. 5 a cross section through a supporting profile and connecting profile in accordance with the invention as per a fifth embodiment, and

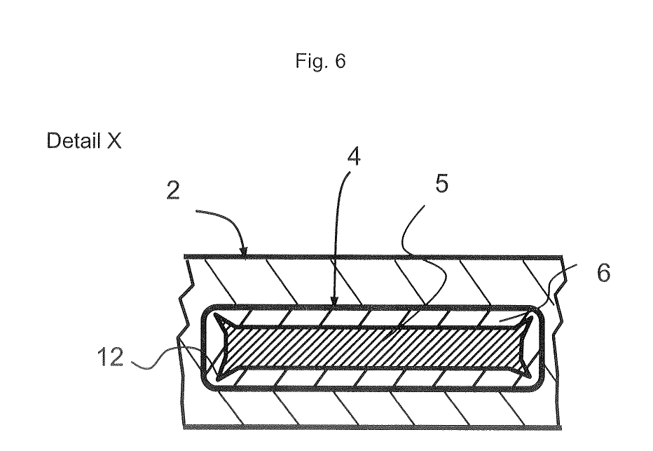

FIG. 6 detail X of FIGS. 4 and 5, enlarged.

FIG. 1 shows a supporting profile and connecting profile 1 according to the invention with a supporting profile body and connecting profile body 2 that is shown in cross section. The profile has an essentially rectangular form and is provided with slots 3 that are open toward the outside at the respective corners, in which fastening elements and/or functional elements that are not shown, for example, walls that can be fastened by pipings (cord edges/welts) can be connected. At short sides of the cross section that are opposite to each other, at the interior of the profile body 2, between two slots 3, a chamber 4 is formed respectively that extends in a cross section that is perpendicular to the longitudinal direction of the profile body and which is provided with a reinforcing insert 5. In the embodiment illustrated, the chambers 4 are provided with at least one essentially rectangular cross section, whereby the width of the chambers 4, i.e. the distance between slots 3 is larger than the thickness of the chambers. This embodiment makes a particularly high bending strength of profile 1 possible.

The reinforcing insert 5 is preferably formed by fibers that extend unidirectional, especially of carbon and/or glass, and a matrix 6 surrounding such. The reinforcing insert is fixated in chamber 4, by casting or gluing the fibers to the matrix in the chamber.

A further variant for fixating the reinforcing insert 5 into chamber 4 is shown in FIG. 2. Illustrated here as well is the supporting profile and connecting profile 1 consisting of the supporting profile and connecting profile 2 shown in cross section and the slots 3 at the corners of the profile body 2. In contrast to the embodiment as per FIG. 1, the profile body 2 shown in FIG. 2 is provided with a bar 7 located essentially in the middle of the profile cross section, which connects the two long sides of the profile body 2 with each other. In bar 7, a chamber 7 is formed which houses the reinforcing insert 5. The reinforcing insert 5 is fixated to bar 7 by means of a rivet connection 8.

Instead of a rivet connection, other connections are also possible, such as, for example, screw connections. Even the bar can be varied depending on the application. Thus, it is also possible that the bar connects the two short sides of the profile body or connects the corners diagonally with each other. Likewise, the profile body 2 can be provided with a number of bars and the bars in turn can have a number of chambers. Beyond that, the chamber 4 does not need to be designed in one piece with the profile body 2 as shown in FIGS. 1 and 2, but can be formed by a number of elements such as, for example, by a chamber that is formed, at least in sections, by a wall section of the profile body, as well as by a separate covering.

This type of an embodiment of a profile is shown in FIG. 3, which has a similar construction as the supporting profile and connecting profile 1 shown in FIG. 1. The chambers 4 are respectively designed for one, by a wall section 9 which is mounted in the profile body 2 in this embodiment, as well as by a covering 10. The reinforcing insert 5 is in this chamber 4, which is fixated by means of, for example, by being molded in, adhesion, screws, rivets or also by the covering 10 itself. The covering 10 is connected with the profile body 2 by means of detachable connections 11 such as, for example, clamp, catch, snap or plug connections. Additional variants comprise clamps with coverings at the inner sides of the profile body. Thereby, it is in principle also possible to locate the covering not in the cut-out wall section 9 on the surface of profile body 2, but directly on the surface of profile body 2. The covering 10 or a cover that locks a wall section 9 can also be connected by adhesion with the profile body 2 and/or the reinforcing insert 5.

FIGS. 4 and 5 respectively show additional embodiments of a supporting profile and connecting profile 1 in accordance with the invention, whereby respectively, similar to the embodiment as per FIG. 1, in the proximity of the upper side as well as in the proximity of the lower side of profile body 2, a closed chamber 4 is provided respectively, into which a fiber reinforcement 5 is inserted and glued. The profile bodies as per FIGS. 4 and 5 are designed in such a way that the profile body as per FIG. 5 can be inserted into the profile body as per FIG. 4. Thus, the profile body as per FIG. 5 is suitable as a connecting element between two profile bodies that are adjacent to each other as per FIG. 4.

In the detail view X of FIG. 6 it can be seen that in the embodiment as per FIGS. 4 and 5, a protrusion 12 is provided respectively at the corners of the reinforcing insert 5 that points approximately into the corresponding corners of the chambers 4. This protrusion 12 forms a guide element and/or distance element extending in the longitudinal direction of the profile body 2, which is to ensure that the reinforcing insert 5 does not abut two-dimensionally at one of the walls of the closed chamber 4, but that the reinforcing insert 5—perhaps with the exception of the guide elements and/or distance elements 12—can be glued two-dimensionally to the inner side of chamber 4. In this way, the reinforcing insert 5 is enclosed on all sides by an adhesive film 6 that has a layer thickness of approximately 0.5 mm. As a result of this, it is possible that the profile body 2 releases tensile forces and compressive forces into the fiber reinforcement when subjected to bending stress.

### REFERENCE NUMBERS

1 supporting profile and connecting profile
2 profile body
3 slot
4 chamber
5 reinforcing insert
6 fixation means
7 bar
8 slot connection
9 wall section
10 covering
11 detachable covering connection
12 guide element and/or distance element

1. Supporting profile and connecting profile (1) made of light metal for a self-supporting scaffold, particularly for light construction halls and large tent structures, with at least one reinforcing insert (5) extending in the longitudinal direction of the profile body made of a fiber composite material, where in a cross section of the profile body (2) that is perpendicular to the longitudinal direction of the profile body (2) at least one closed chamber (4) is formed, in which the at least one reinforcing insert (5) is fixated by material connection, form-fit and/or force-fit.

2. Supporting profile and connecting profile according to claim 1 wherein the at least one reinforcing insert (5) is molded into and/or glued into a chamber (4).

3. Supporting profile and connecting profile according to claim 1 where the at least one reinforcing insert (5) is fixated by means of a rivet or screw connection in a chamber (4).

4. Supporting profile and connecting profile according to claim 1 where the at least one closed chamber (4) is designed in one piece with profile body (2).

5. Supporting profile and connecting profile according to claim 1 wherein the at least one closed chamber (4) is designed in sections by a wall section (9) of profile body (2), as well as by a separate covering (10), cap or the like.

6. Supporting profile and connecting profile according to claim 1, where in a cross section of the profile body (2) that is perpendicular to the longitudinal direction of the profile body (2), the lumen of the at least one closed chamber (4) is larger than the reinforcing insert (5).

7. Supporting profile and connecting profile according to claim 1, wherein on the inside of the at least one closed chamber (4) and/or on the outside of the reinforcing insert (5), at least one guide element and/or distance element (12) is provided.

8. Supporting profile and connecting profile according to claim 7, wherein at least one guide element and/or distance element (12) is designed as a rib that essentially extends in the longitudinal direction of the profile body (2).

9. Supporting profile and connecting profile according to claim 1, characterized by, that chemicals are mixed into the profile body (2) to achieve more fire resistance, for example, alum in umtri hydrate, bromide or the like.

10. Supporting profile and connecting profile according to claim 1, wherein its length is larger, at least by a factor of 20, especially approximately by a factor of 50 to approximately a factor of 150, than its width and/or height.

11. Supporting profile and connecting profile according to claim 1, characterized by, that the profile body (2) is almost rectangular in a cross section that is perpendicular to the longitudinal direction of the profile body (2), whereby its height is larger than its width, and whereby in at least two, especially in all four corners a nut (3) is respectively provided to house a corded welting/welt.

12. Method for the production of a fiber-reinforced metal profile, especially of a supporting profile and connecting profile according to one of the preceding claims, with the following procedural steps:
(a) providing a profile body (2) in which at least one closed chamber (4) is formed in a cross section that is perpendicular to the longitudinal direction of the profile body (2),
(b) pouring an adhesive (6) into the at least one closed chamber (4),
(c) inserting a reinforcing insert (5) containing glass fibers and/or carbon fibers together with adhesive (6) into the at least one closed chamber (4).

13. Method according to claim 12, wherein the adhesive (6) has a viscosity between approximately 1,000 mPas and approximately 3,500 mPas, particularly approximately 2,100 mPas to approximately 2,500 mPas.

14. Method according to claim 12, where in step (c) between the outer side of the reinforcing insert (5) and the inner side of the chamber (4) an adhesive film (6) is created on all sides that has a layer thickness off at least 0.3 mm, particularly between 0.4 mm and approximately 2.5 mm.

15. Method according to claim 12, wherein the profile body (2) has an almost rectangular cross section, the height of which is larger than its width, whereby in the proximity of the upper side and in the proximity of the lower side a closed chamber (4) is formed respectively, and whereby an adhesive (6) and a reinforcing insert (5) is inserted into each of these two chambers (4) as per steps (b) and c).
